(19) United States
(12) Patent Application Publication
(10) Pub. No.: US 2019/0091837 A1
(43) Pub. Date: Mar. 28, 2019

(54) Engagement structure for tool

(71) Applicant: Ting Ya Huang, Taichyung City (TW)

(72) Inventor: Ting Ya Huang, Taichyung City (TW)

(21) Appl. No.: 16/137,545

(22) Filed: Sep. 21, 2018

(30) Foreign Application Priority Data
Sep. 26, 2017 (TW) 106214320

(51) Int. Cl. B25B 13/46; B25B 13/06

(52) U.S. Cl. CPC B25B 13/46; B25B 13/065

(57) ABSTRACT

An engagement structure for a tool contains: a body which includes an accommodation orifice defined in the body. The body further includes a polygonal tooth section formed around an inner wall of the accommodation orifice, wherein the polygonal tooth section has three tip protrusions formed on each of multiple sides thereof. Thereby, the body is operated to rotate an object in an irregular shape by using the three tip protrusions of each side of the polygonal tooth section, and the object has at least one notch formed around a peripheral side thereof.

### FIELD OF THE INVENTION

The present invention relates to an engagement structure for a tool which is capable of operate an object in an irregular shape by using the three tip protrusions of each side of the polygonal tooth section, and the object has at least one notch formed around a peripheral side thereof.

### BACKGROUND OF THE INVENTION

Sockets or wrenches are applied to rotate objects of various sizes respectively.

Referring to FIGS. 1-3, a conventional engagement structure for a tool contains a body 10, and the body 10 includes an accommodation orifice 11 defined therein and includes a polygonal tooth section 12 formed around an inner wall of the accommodation orifice 11. After an object 13 is received in the accommodation orifice 11, the body 10 rotates the object 13 by ways of the polygonal tooth section 12. However, the body 10 cannot rotate another object 14 with at least one notch by using the polygonal tooth section 12.

The present invention has arisen to mitigate and/or obviate the afore-described disadvantages.

### SUMMARY OF THE INVENTION

The primary aspect of the present invention is to provide an engagement structure for a tool which is capable of operate an object in an irregular shape by using the three tip protrusions of each side of the polygonal tooth section, and the object has at least one notch formed around a peripheral side thereof.

### BRIEF DESCRIPTION OF THE DRAWINGS

FIG. 1 is a schematic view showing the assembly of a conventional engagement structure for a tool.

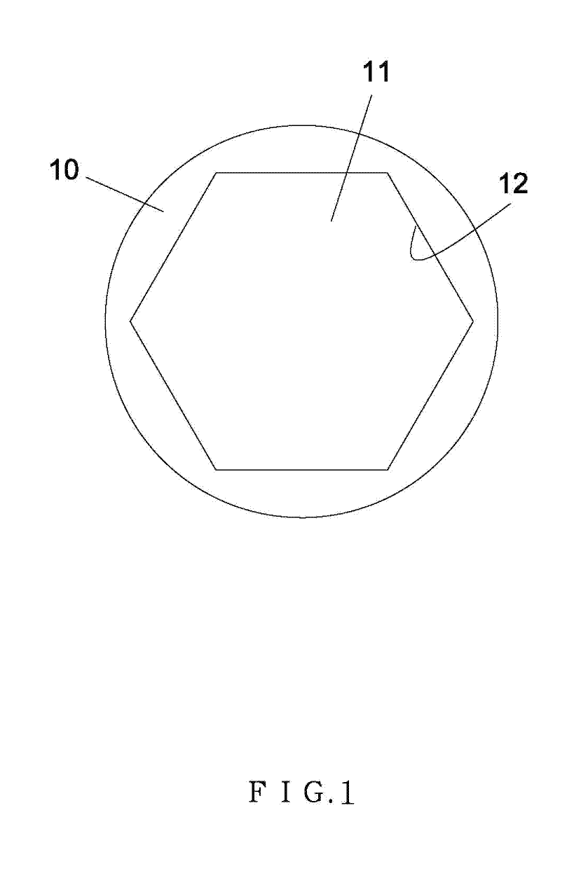

FIG. 2 is a schematic view showing the operation of the conventional engagement structure for the tool.

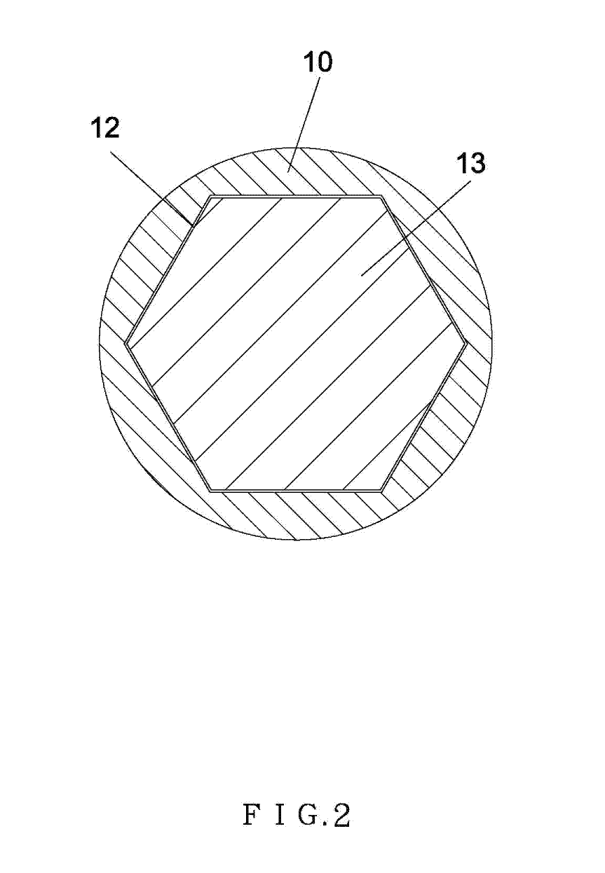

FIG. 3 is another schematic view showing the operation of the conventional engagement structure for the tool.

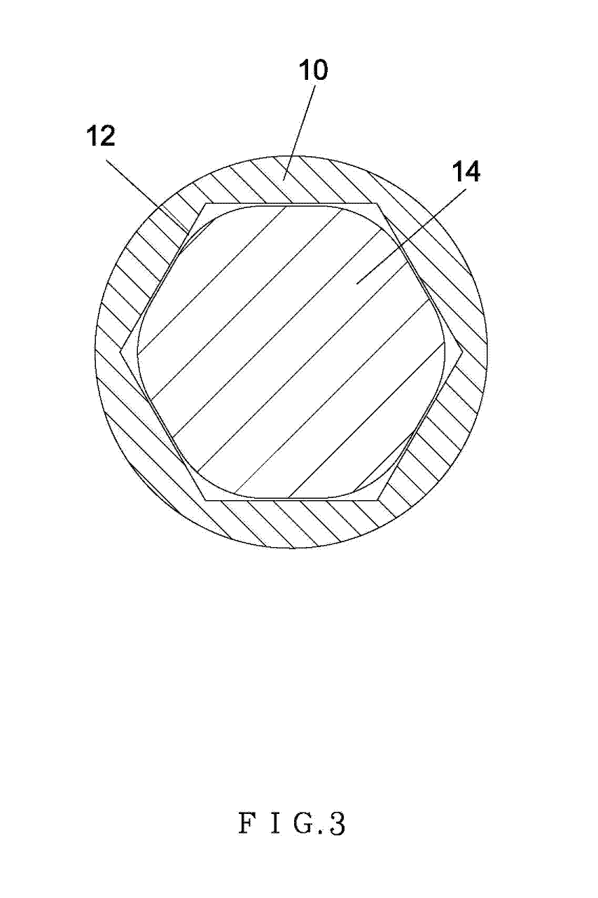

FIG. 4 is a schematic view showing the assembly of an engagement structure for a tool according to a preferred embodiment of the present invention.

FIG. 5 is a schematic view showing the operation of the engagement structure for the tool according to the preferred embodiment of the present invention.

FIG. 6 is another schematic view showing the operation of the engagement structure for the tool according to the preferred embodiment of the present invention.

FIG. 7 is also another schematic view showing the operation of the engagement structure for the tool according to the preferred embodiment of the present invention.

FIG. 8 is a perspective view showing the application of the engagement structure for the tool according to the preferred embodiment of the present invention.

FIG. 9 is another perspective view showing the application of the engagement structure for the tool according to the preferred embodiment of the present invention.

### DETAILED DESCRIPTION OF THE PREFERRED EMBODIMENTS

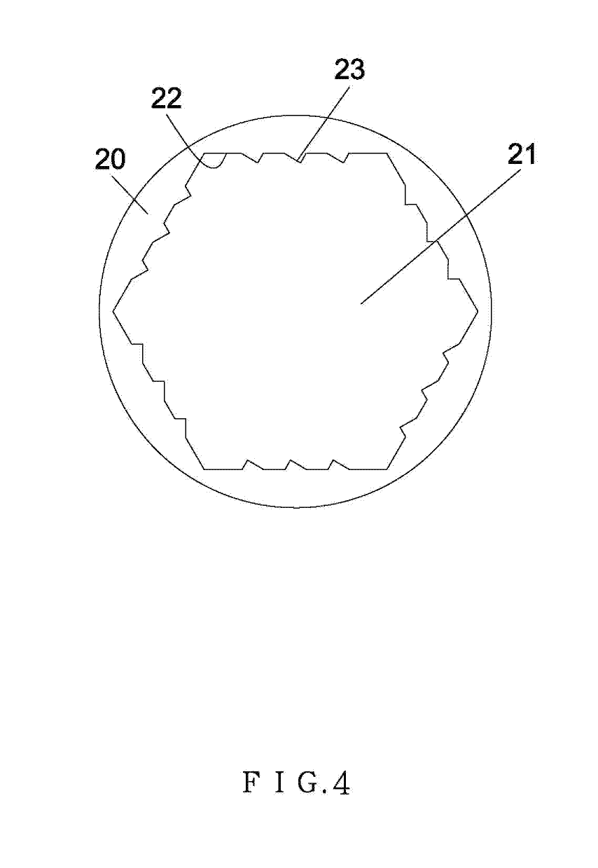

With reference to FIG. 4, an engagement structure for a tool according to a preferred embodiment of the present invention comprises: a body 20, and the body 20 includes an accommodation orifice 21 defined therein and includes a polygonal tooth section 22 formed around an inner wall of the accommodation orifice 21, wherein the polygonal tooth section 22 has three tip protrusions 23 formed on each of multiple sides thereof.

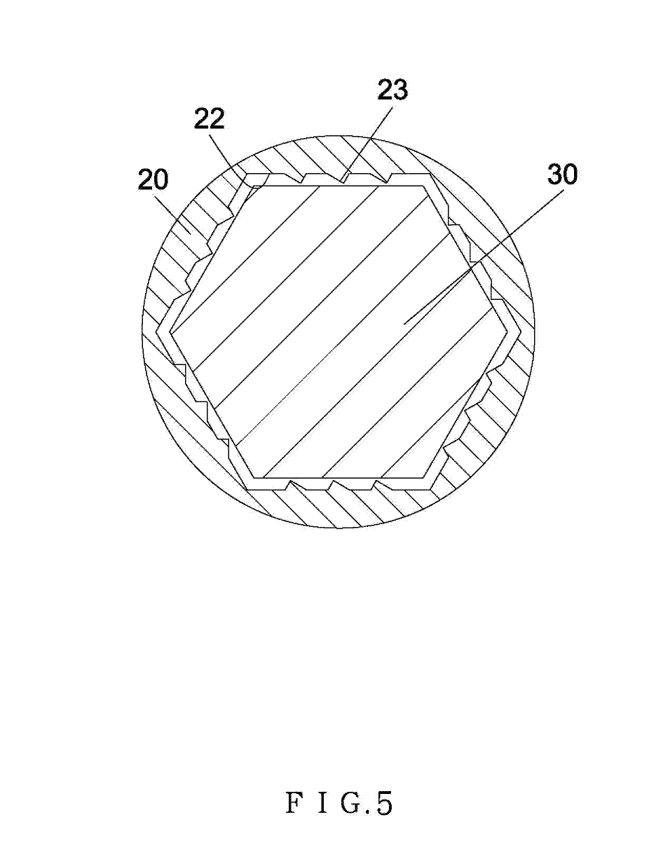

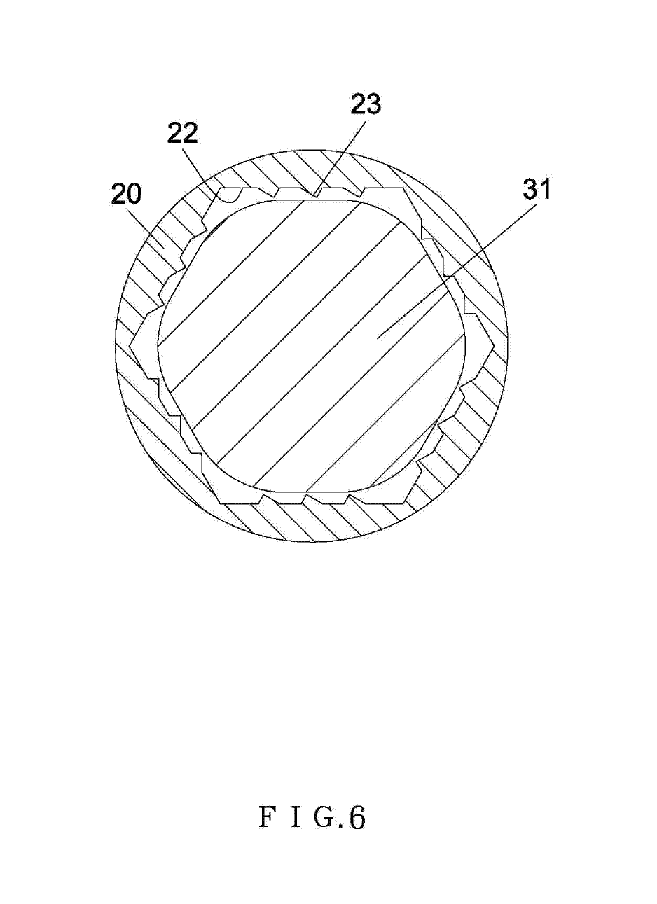

Referring to FIG. 5-6, the body 20 is operated to rotate an object 30 in a polygonal or circle shape by using the three tip protrusions 23 of each side of the polygonal tooth section 22.

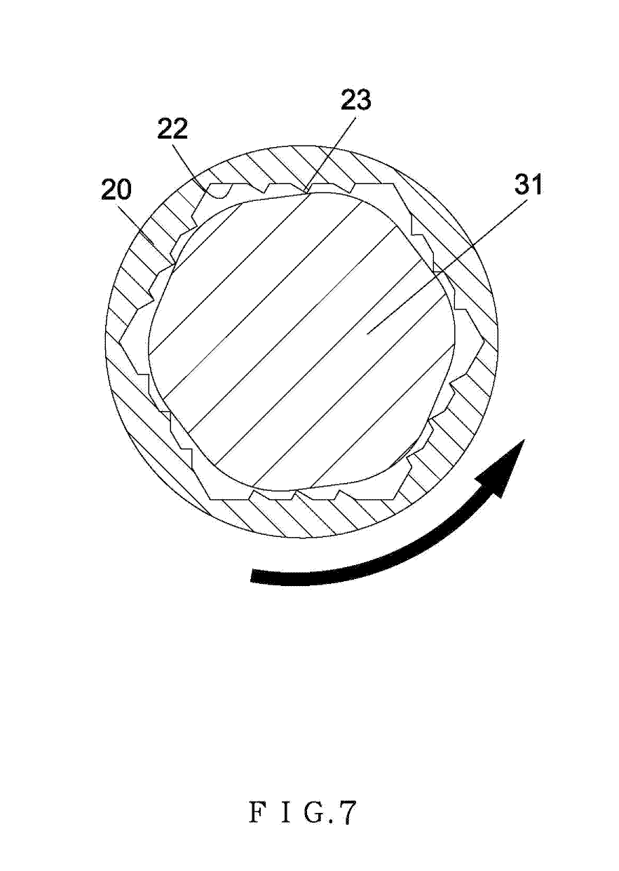

As shown in FIGS. 7, the body 20 of the tool is operated to rotate an object 31 in an irregular shape by using the three tip protrusions 23 of each side of the polygonal tooth section 22, wherein the object 31 has at least one notch formed around a peripheral side thereof.

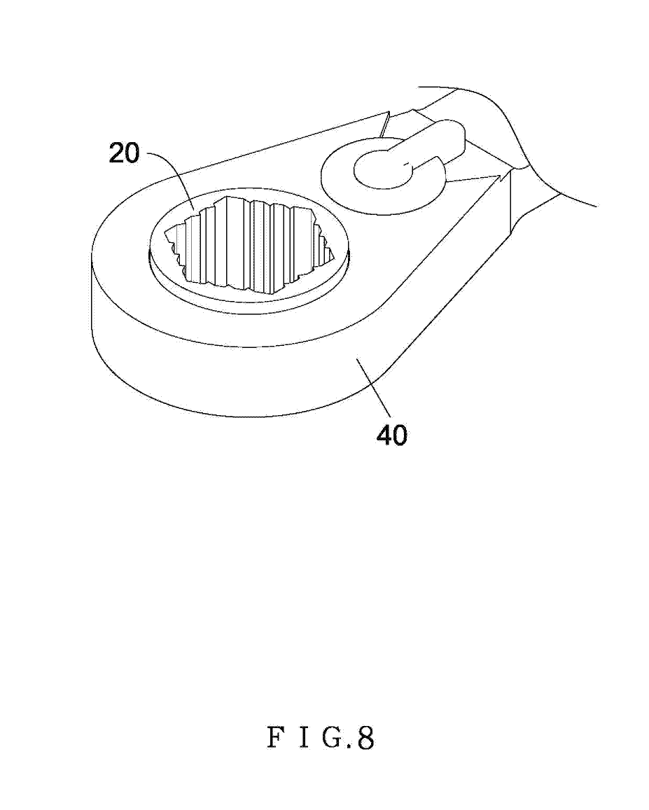

As illustrated in FIG. 8, the tool is a ratchet wrench 40, and the body 20 is formed in the ratchet wrench 40.

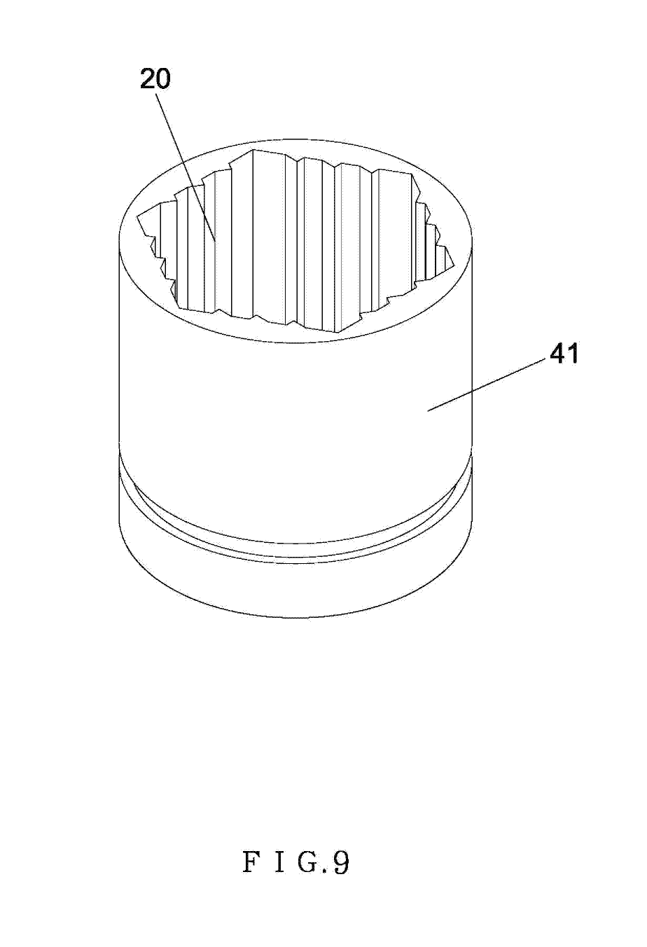

As shown in FIG. 9, the tool is a socket 41, and the body 20 is formed in the socket 41.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. An engagement structure for a tool comprising:
a body, and the body including an accommodation orifice defined in the body, and the body including a polygonal tooth section formed around an inner wall of the accommodation orifice;
wherein the polygonal tooth section has three tip protrusions formed on each of multiple sides thereof.
wherein the body is operated to rotate an object in an irregular shape by using the three tip protrusions of each side of the polygonal tooth section, and the object has at least one notch formed around a peripheral side thereof.

2. The engagement structure for the tool as claimed in claim 1, wherein the body is formed in a ratchet wrench or a socket.
